(19) United States
(12) Patent Application Publication
(10) Pub. No.: US 2025/0326335 A1
(43) Pub. Date: Oct. 23, 2025

(54) RATCHETING STRAP SYSTEM FOR A CHILD CAR SEAT

(71) Applicant: Corbin Cress, Marion, VA (US)

(72) Inventor: Corbin Cress, Marion, VA (US)

(21) Appl. No.: 18/639,791

(22) Filed: Apr. 18, 2024

(51) Int. Cl. B60N 2/28

(52) U.S. Cl. CPC B60N 2/2806

(57) ABSTRACT

A ratcheting strap system for a child car seat, including a static strap assembly, including a static strap to connect to a component within a car at a first end of the static strap, a retractable strap assembly, including a retractable strap to connect to another component within the car at a first end of the retractable strap, wherein at least a portion of the retractable strap is threaded through a portion of the child car seat to secure the child car seat to a seat of the car, and a ratcheting system, including a ratcheting system housing to connect to a second end of the static strap at a first side of the ratcheting system housing and to connect to a second end of the retractable strap at a second side of the ratcheting system housing.

### BACKGROUND

### 1. Field

The present general inventive concept relates generally to a ratcheting strap system, and particularly, to a solar powered cooler with a ratcheting strap system for a child car seat.

### 2. Description of the Related Art

Traditional child car seat straps rely on a pull-and-release mechanism, leaving parents and caregivers struggling to achieve the level of tightness necessary for optimal safety during transport.

In addition, the task of moving a car seat from one vehicle to another can be a tedious process, especially when individuals are uncertain if they've secured the support seating tight enough for proper utilization.

Therefore, there is a need for a device for a child car seat that quickly and effectively secures the child car seat to a seat of a car.

There is also a need for a device for a child car seat that quickly and effectively detaches the child car seat from a seat of a car.

### SUMMARY

The present general inventive concept provides a ratcheting strap system for a child car seat.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a ratcheting strap system for a child car seat, including a static strap assembly, including a static strap to connect to a component within a car at a first end of the static strap, a retractable strap assembly, including a retractable strap to connect to another component within the car at a first end of the retractable strap, wherein at least a portion of the retractable strap is threaded through a portion of the child car seat to secure the child car seat to a seat of the car, and a ratcheting system, including a ratcheting system housing to connect to a second end of the static strap at a first side of the ratcheting system housing and to connect to a second end of the retractable strap at a second side of the ratcheting system housing.

The ratcheting system may further include a retracting drum disposed within the ratcheting system housing to allow at least a portion of the retractable strap to spool around the retracting drum, such that the retracting drum rotates in a first direction to allow the retractable strap to extend in length outside of the ratcheting system housing, and a handle pivotably connected to the ratcheting system housing to cause the retracting drum to rotate in a second direction in response to the handle being pivoted, such that the retractable strap wraps around the retracting drum and such that the retractable strap shortens in length outside of the ratcheting system housing.

### BRIEF DESCRIPTION OF THE DRAWINGS

These and/or other features and utilities of the present generally inventive concept will become apparent and more readily appreciated from the following description of the embodiments, taken in conjunction with the accompanying drawings ofwhich:

FIG. 1 illustrates a ratcheting strap system for a child car seat, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### List of Components

Ratcheting Strap System for a Child Car Seat100
Static Strap Assembly 110
Static Strap 111
Static Strap Securing Member 112
Retractable Strap Assembly 120
Retractable Strap 121
Retractable Strap Securing Member 122
Ratcheting System 130
Ratcheting System Housing 131
Strap Slot 132
Strap Retracting Drum 133
Gear 134
Retracting Clock Spring 135
Handle 136
Locking Pin 137
Locking Pin Slot 138

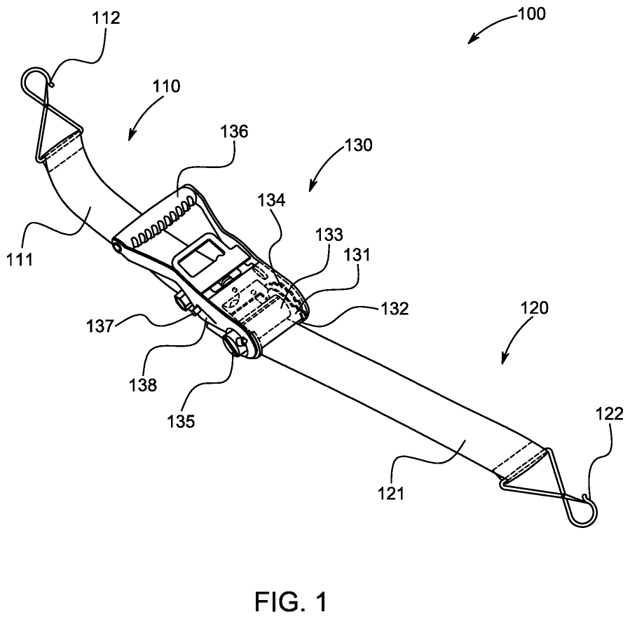

FIG. 1 illustrates a ratcheting strap system for a child car seat 100, according to an exemplary embodiment of the present general inventive concept.

The ratcheting strap system for a child car seat 100, and all components therein and/or connected thereto, may be constructed from at least one of metal, plastic, wood, silicone, cloth, and rubber, etc., but is not limited thereto, and can be constructed from any material known to one of ordinary skill in the art.

Referring to FIG. 1, the ratcheting strap system for a child car seat 100 may include a static strap assembly 110, a retractable strap assembly 120, and a ratcheting system 130, but is not limited thereto.

The static strap assembly 110 and the retractable strap assembly 120 may both be connected to the ratcheting system 130, but are not limited thereto, and may be detachably connected thereto.

The static strap assembly 110 may include a static strap 111 and a static strap securing member 112, but is not limited thereto.

The static strap 111 may be a strap that does not increase or decrease in length, and may include the static strap securing member 112 connected thereto at a first end thereof, and may be connected to the ratcheting system 130 at a second endthereof.

The static strap securing member 112 may be a hook, pin, bar, clamp, or any other type of securing member known to one of ordinary skill in the art, which has the ability to attach to a component within a car to secure the static strap 111 to the car.

The retractable strap assembly 120 may include a retractable strap 121 and a retractable strap securing member 122, but is not limited thereto.

The retractable strap 121 may be a strap that is adjustable and has the ability to increase or decrease in length, and may include the retractable strap securing member 122 connected thereto at a first end thereof, and may be connected to the ratcheting system 130 at a second end thereof.

The retractable strap securing member 122 may be a hook, pin, bar, clamp, or any other type of securing member known to one of ordinary skill in the art, which has the ability to attach to a component within a car to secure the retractable strap 121 to thecar.

The ratcheting system 130 may include a ratcheting system housing 131, a strap slot 132, a strap retracting drum 133, a gear 134, a retracting clock spring 135, a handle 136, a locking pin 137, and a locking pin slot 138, but is not limited thereto.

The ratcheting system housing 131 may include all of the other components of the ratcheting system attached thereto or housed therein.

The second end of the retractable strap 121 may be threaded through the strap slot 132, such that the retractable strap 121 may be connected to the strap retracting drum 133.

The retractable strap 121 may be extended by pulling on the first end of the retractable strap 121, thereby increasing an amount of the retractable strap that is disposed outside of the ratcheting system housing 131.

The gear 134 may be attached to the strap retracting drum 133 to regulate an amount (i.e., a distance) that the retractable strap 121 is extended, such that each notch of the gear 134 causes the retractable strap 121 to extend a predetermined distance as the retractable strap 121 is pulled away from the ratcheting system housing 131.

The retracting clock spring 135 may allow for the strap retracting drum 133 to perform a retraction of the retractable strap 121.

Manipulation of the handle 136 may cause the retracting clock spring 135 to engage, such that a lifting of the handle 136 (e.g., a pivoting of the handle 136 at a fulcrum point of attachment with the ratcheting system housing 131) causes the retracting clock spring 135 to cause the strap retracting drum 133 to rotate and thereby perform a retraction of the retractable strap 121 into the ratcheting system housing 131 (i.e., the rotation of the strap retracting drum 133 causes the retractable strap 121 to wrap around the strap retracting drum 133), thus shortening a length of a portion of the retractable strap 121 that is disposed outside of the ratcheting system housing 131.

The locking pin 137 may allow the retractable strap 121 to maintain a predetermined extended length in a locked position, by sliding the locking pin 137 from a first position within the locking pin slot 138 to a second position within the locking pin slot138.

Therefore, a user can quickly attach a child car seat to a seat of a car by using the ratcheting strap system for a child car seat 100, specifically, by attaching the static strap securing member 112 to a component within the car, threading the retractable strap 121 through the child car seat, attaching the first end of the retractable strap 121 to another component within the car, and then lifting the handle 136 to tighten the retractable strap 121 (i.e., the retractable strap 121 will be slightly wound around the strap retracting drum 133 within the ratcheting system housing 131 to tightly secure the child car seat to the seat of the car), and then locking the retractable strap 121 at the desired length and tightness by moving the locking pin 137 from a first position within the locking pin slot 138 to a second position within the locking pin slot 138.

The present general inventive concept introduces a ratcheting strap system for a child car seat 100, including a static strap assembly 110, including a static strap 111 to connect to a component within a car at a first end of the static strap 111, a retractable strap assembly 120, including a retractable strap 121 to connect to another component within the car at a first end of the retractable strap 121, wherein at least a portion of the retractable strap 121 is threaded through a portion of the child car seat to secure the child car seat to a seat of the car, and a ratcheting system 130, including a ratcheting system housing 131 to connect to a second end of the static strap 111 at a first side of the ratcheting system housing 131 and to connect to a second end of the retractable strap 121 at a second side of the ratcheting system housing 131.

The ratcheting system 130 may further include a retracting drum 133 disposed within the ratcheting system housing 131 to allow at least a portion of the retractable strap 121 to spool around the retracting drum 133, such that the retracting drum 133 rotates in a first direction to allow the retractable strap 121 to extend in length outside of the ratcheting system housing 131, and a handle 136 pivotably connected to the ratcheting system housing 131 to cause the retracting drum 133 to rotate in a second direction in response to the handle 136 being pivoted, such that the retractable strap 121 wraps around the retracting drum 133 and such that the retractable strap 121 shortens in length outside of the ratcheting system housing 131.

A main purpose of the present general inventive concept is to provide users with a ratcheting car seat strap that facilitates child car seat installation. Ingenious and practical, the present general inventive concept offers a modern accessory that allows users to tighten their child's car seat, up to three times tighter than standard straps, ensuring a car seat is locked into place effectively.

The present general inventive concept introduces a novel ratcheting system crafted from robust steel and nylon materials. The ratcheting system features a locking pin that does not come loose unless manually released and a tension spring that prevents over tightening during set-up so as to not compromise the structure of the car seat. Building on the concept used to hold heavy loads, the present general inventive concept is meant for a person to slide the long end of the strap through the bottom seat where the primary strap is located, then to hook both ends to a vehicle's existing latches, to ratchet the accessory until the handle stops once in the formal locking position, and finally, to place the safety pin through pre-drilled holes to secure its positioning. To further enhance functionality, this avant-garde product is fully retractable to simplify installation, making it a quick and easy process to secure a child's car seat into any vehicle, regardless of make or model. With the present general inventive concept, users can confidently and effortlessly secure a child's car seat, a benefit to parents around the globe; thus, the present general inventive concept may prove to be essential in the child/infant industry.

The present general inventive concept is the only product of its kind that utilizes a ratcheting mechanism to secure a child seat three times more tightly into a vehicle than current methods. This unprecedented product is uniquely designed to come in a wide variety of colors and themes, per gender, to suit diverse preferences and is carefully crafted with durable, high-quality materials to ensure long-term sustainability.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A ratcheting strap system for a child car seat, comprising:
a static strap assembly, comprising a static strap to connect to a component within a car at a first end of the static strap;
a retractable strap assembly, comprising a retractable strap to connect to another component within the car at a first end of the retractable strap, wherein at least a portion of the retractable strap is threaded through a portion of the child car seat to secure the child car seat to a seat of the car; and
a ratcheting system, comprising a ratcheting system housing to connect to a second end of the static strap at a first side of the ratcheting system housing and to connect to a second end of the retractable strap at a second side of the ratcheting system housing.

2. The ratcheting strap system for a child car seat of claim 1, wherein the ratcheting system further comprises:
a retracting drum disposed within the ratcheting system housing to allow at least a portion of the retractable strap to spool around the retracting drum, such that the retracting drum rotates in a first direction to allow the retractable strap to extend in length outside of the ratcheting system housing; and
a handle pivotably connected to the ratcheting system housing to cause the retracting drum to rotate in a second direction in response to the handle being pivoted, such that the retractable strap wraps around the retracting drum and such that the retractable strap shortens in length outside of the ratcheting system housing.
